(19) United States
(12) Patent Application Publication
(10) Pub. No.: US 2020/0163332 A1
(43) Pub. Date: May 28, 2020

(54) METHOD OF IMPROVING CROP SAFETY

(71) Applicant: Bayer CropScience LP, St. Louis, MO (US)

(72) Inventors: Lakshmi Praba MANAVALAN, Davis, CA (US); Leonela G. CARRIEDO, Sacramento, CA (US)

(21) Appl. No.: 16/606,461

(22) PCT Filed: Apr. 19, 2018
(86) PCT No.: PCT/US2018/028271

§ 371 Date: Oct. 18, 2019

Related U.S. Application Data
(60) Provisional application No. 62/488,598, filed on Apr. 21, 2017.

(51) Int. Cl. A01N 25/32

(52) U.S. Cl. CPC A01N 25/32; A01N 43/653

(57) ABSTRACT

The present invention relates to the use of antioxidants and/or nutrients for improving crop safety in plants, a composition comprising antioxidants and a new method of plant treatment wherein is antioxidants and/or nutrients applied to a plant, a plant part, plant propagation material or the habitat the plant is growing in to improve crop safety.

### CROSS-REFERENCE TO RELATED APPLICATIONS

This application claims priority to U.S. Provisional Patent Application No. 62/488,598, filed Apr. 21, 2017, the contents of which are incorporated herein by reference in their entirety.

### TECHNICAL FIELD

The present invention relates to the use of antioxidants and/or nutrients for improving crop safety and a new method of plant treatment wherein one or more antioxidant and/or nutrient is applied to a plant, a plant part, plant propagation material or the habitat the plant is growing in for improving crop safety.

### BACKGROUND

Active ingredients in agriculture used to control microorganisms, weeds or animal pests might have in addition to their microbicidal, herbicidal or pesticidal activity also negative effects on the target crop, particularly at early growth. Examples for such an activity include growth distortion, necrotic areas, bleaching, oxidative damage, stunting. These effects will depend on the crop, its life stage, the concentration of the active ingredient and the environment the crop is growing in. For example certain herbicides which are chemically similar to auxins will act in higher concentration as herbicides while they might act as a growth enhancer in lower concentrations. The underlying mechanisms of such impacts on the plants are not yet understood, but processes like oxidative stress or cellular damage might play a role here. Such compounds are defined to have a negative impact on crop safety at early stages of establishment. These kind of unwanted effects are of particular concern in seeds, germinating seeds or seedlings when the active ingredient is applied as seed treatments and or soil application. One example for such effects of active ingredients is the so called “halo-effect” of the fungicide and nematicide Fluopyram in soy seedlings at the early establishment phase, while at later growth stages starting as of BBCH stage 13 these effects are overcome by the plants. Therefore it is very important to ensure that these effects are mitigated at the plant establishment phase. The reasons for these kinds of unwanted effects are unclear. Current examples of such mitigation measurements are lowering the dosage rates which often leads also to a decreased efficacy of the active ingredients. Consequently, it is an interest to provide compounds or small molecules which may enhance crop safety in particular in seeds, germinating seeds and seedlings, in particular at the early establishment of plants. Antioxidants have been disclosed regarding the protective role both in plants and animals. For example, ascorbate level are increased in plants which are exposed to high light and ascorbate deficient mutants of Arabidopsis show an increased level of lipid peroxidation and photoinhibition when exposed to high light (Mueller-Moule, et al., Plant Physiol. 2003; 133(2): 748-760). Other antioxidants such as carotenoids, have shown an impact on cell viability of human prostate cancer cells where the exact role of these class of antioxidants still remains to be clarified (Kotake-Nara, et al., Journal of Nutrition, 2001, 3304-3306).

There is an interest to provide a method of improving crop safety to plants at different stages of a plant lifetime, in particular until the early establishment (BBCH stage 13).

It is therefore an object of the present invention to provide a method for improving crop safety, in particular until the early establishment (BBCH stage 13).

### SUMMARY

The present invention describes the use of antioxidants and/or nutrients for improving crop safety in plants, a composition comprising at least one antioxidant and/or nutrient and a method of plant treatment wherein at least one antioxidant and/or nutrient is applied to a plant, a plant part, plant propagation material, in particular seeds or the habitat the plant is growing in to improve crop safety.

Antioxidants and nutrients used in the method of the present invention have been found to display different degrees of improving crop safety, depending upon the concentration used, the formulation employed and the type of plant species treated.

In certain aspects, the present invention relates to the use of antioxidants and/or nutrients for improving crop safety in plants. The improved crop safety effect may be selected from the group consisting of a) increased area of healthy tissue, b) a lower amount of reactive oxygen species, c) an increase in cotyledon, unifoliate, and/or trifoliate leaf area, and d) an increase in plant height.

In one aspect, the antioxidants are applied as a seed treatment. In another aspect, the nutrients are applied as a seed treatment.

In certain embodiments, the nutrients are macro-nutrients. In other embodiments, the nutrients are micro-nutrients. In yet other embodiments, the nutrients are a combination of micro-nutrients and macro-nutrients.

In one aspect, the plant is selected from the group comprising Fabaceae.

In another aspect, the antioxidants and/or nutrients are applied at an application rate of 0.001 g/100 kg seeds to 250 g/100 kg of seeds for the antioxidants and/or at an application rate of 0.01 g/100 kg seeds to 50 g/100 kg of seeds for the nutrients.

In one embodiment, the antioxidants and/or nutrients are applied in combination with herbicides, insecticides, growth regulators, fungicides or biological control agents. The antioxidants and/or nutrients may be applied simultaneously or sequentially with at least one active ingredient. In certain aspects, the at least one active ingredient is selected from the group comprising Flupyradifurone, Prothioconazole, Tebuconazole and Fluopyram.

In some embodiments, the nutrients comprise calcium. In one embodiment, the nutrients comprising calcium are selected from the group consisting of calcium acetate, calcium ammonium nitrate, calcium borate, calcium carbonate, calcium chelate, calcium chloride, calcium cyanamide, calcium dihydrogen phosphate, calcium fluoride, calcium hydrogen phosphate, calcium hydroxide, calcium nitrate, calcium oxalate, calcium oxide, calcium phosphate, calcium silicate, calcium sulfate, dolomitic lime (CaMg(CO₃)₂), hydrated lime (Ca(OH)₂), quick lime (CaO), tricalcium phosphate, and combinations thereof.

In one aspect, the nutrients comprising calcium are selected from the group consisting of calcium ammonium nitrate, calcium borate, calcium carbonate, calcium chelate, calcium chloride, calcium cyanamide, calcium dihydrogen phosphate, calcium hydrogen phosphate, calcium hydroxide, calcium nitrate, calcium oxalate, calcium oxide, calcium phosphate, calcium silicate, calcium sulfate, dolomitic lime (CaMg(CO₃)₂), hydrated lime (Ca(OH)₂), quick lime (CaO), tricalcium phosphate, and combinations thereof.

In another aspect, the nutrients comprising calcium are selected from the group consisting of calcium ammonium nitrate, calcium carbonate, calcium chelate, calcium chloride, calcium cyanamide, calcium dihydrogen phosphate, calcium hydrogen phosphate, calcium hydroxide, calcium nitrate, calcium oxalate, calcium oxide, calcium phosphate, calcium silicate, calcium sulfate, tricalcium phosphate, and combinations thereof.

In yet another aspect, the nutrients comprising calcium are selected from the group consisting of calcium carbonate, calcium chloride, calcium dihydrogen phosphate, calcium hydrogen phosphate, calcium nitrate, calcium phosphate, calcium sulfate, tricalcium phosphate, and combinations thereof. In one aspect, the nutrient comprising calcium is calcium chelate. The chelating agent in calcium chelate may be EDTA (ethylenediaminetetraacetic acid).

In one aspect, the present invention provides a method for treating plants in need of improving crop safety, comprising applying antioxidants and/or nutrients to said plants, to the seeds from which they grow or to the locus in an non-phytotoxic amount which is effective to improve crop safety.

In certain aspects, the antioxidants and/or nutrients are applied simultaneously, that is either together or separately, or sequentially with at least one active ingredient selected from the group comprising Flupyradifurone, Prothioconazole, Tebuconazole and Fluopyram.

In other embodiments, the present invention relates to an agrochemical composition comprising antioxidants and/or nutrients and agriculturally suitable auxiliaries, solvents, carriers, surfactants or extenders. In one aspect, the agrochemical composition comprises antioxidants and/or nutrients and Tebuconazole. In another aspect, the agrochemical composition comprises antioxidants and/or nutrients and Fluopyram. In yet another aspect, the agrochemical composition comprising antioxidants and/or nutrients and Flupyradifurone.

In one embodiment, the agrochemical composition comprises nutrients selected from the group consisting of calcium acetate, calcium ammonium nitrate, calcium borate, calcium carbonate, calcium chelate, calcium chloride, calcium cyanamide, calcium dihydrogen phosphate, calcium fluoride, calcium hydrogen phosphate, calcium hydroxide, calcium nitrate, calcium oxalate, calcium oxide, calcium phosphate, calcium silicate calcium sulfate, dolomitic lime (CaMg(CO3)2), hydrated lime (Ca(OH)2), quick lime (CaO), tricalcium phosphate, and combinations thereof.

### BRIEF DESCRIPTION OF THE DRAWINGS

FIG. 1 depicts the average heights of soybean plants treated with ILeVO® (Fluopyram) alone (“None”) or in combination with various micronutrients or macronutrients.

FIG. 2 depicts the average unifoliate leaf surface area of soybean plants treated with ILeVO® (Fluopyram) alone (“Alone”) or in combination with various micronutrients or macronutrients.

### DETAILED DESCRIPTION

Certain active ingredients may have an impact on a crop at different life stages. One example is the azole Tebuconazole which is known to cause stunting in seedlings/developing plants.

Fluopyram is defined to be the compound of the formula (I)

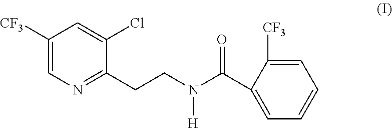 [SMILES: O=C(NCCc1ncc(C(F)(F)F)cc1Cl)c1ccccc1C(F)(F)F]

as well as the N-oxides of the compound thereof.

Fluopyram is a broad spectrum fungicide of the chemical class of pyridylethylbenzamide derivatives with penetrant and translaminar properties for foliar, drip, drench and seed treatment applications on a wide range of different crops against many economically important plant diseases. It is very effective in preventative applications against powdery mildew species, grey mould and white mould species. It has an efficacy against many other plant diseases. Fluopyram has shown activity in spore germination, germ tube elongation and mycelium growth tests. At the biochemical level, Fluopyram inhibits mitochondrial respiration of target pests by blocking the electron transport in the respiratory chain of Succinate Dehydrogenase (complex II-SDH inhibitor).

Fluopyram and its manufacturing process starting from known and commercially available compounds is described in EP-A 1 531 673 and WO 2004/016088. In addition, Fluopyram also provides control of nematodes (WO 2008/0126922) and is known to be effective against Sudden Death Syndrome in soybeans (EP 2642854).

Oxidation is a chemical reaction that can produce free radicals, leading to chain reactions that may damage cells. Antioxidants are molecules that inhibit the oxidation of other molecules. Examples for such classes are carotenoids, Vitamin E derivatives, co-enzymes, Vitamin C Examples of antioxidants are Vitamin C such as L-ascorbic acid, dehydroascorbate, carotenoids such as alpha-carotene, beta-carotene, gamma-carotene, delta-carotene, lycopene, phytoene, phytofluene, beta-cryptoxanthin, canthaxanthin, astaxanthin, capsaanthin, xanthophylls such as violaxanthin, antheraxanthin, zeaxanthin, meso-zeaxanthin, lutein, fucoxanthin, neoxanthin, Vitamin E derivatives like alpha-tocopherol, beta-tocopherol, gamma-tocopherol, delta-tocopherol, co-enzymes like co-enzyme Q10, glutathione, feridoxins, NADH, NADPH, FADH, cytochrome b, cytochrome c.

Nutrients are essential for plant growth, plant metabolism and their external supply as without them the plant is unable to complete a normal life cycle or the element is part of an essential plant constituent (e.g., enzymes) or metabolite. Macro-nutrients are needed in a higher dosage while micro-nutrients may be needed in a lower dosage, e.g., being important as a co-factor for certain enzymes. The exact amount will differ for crops, the life stage they are in or the environmental conditions, e.g., water supply, exposure to light, soil properties, weather.

Macro-nutrients are selected from the group comprising of nitrogen, for example ammonium salts, nitrates, phosphor, for example dihydrogen phosphates, hydrogen phosphates, phosphates, potassium, e.g., potassium salts, calcium, e.g., calcium salts, iron, e.g., iron salts, sulfur, e.g., sulfates or hydrogen sulfates, or magnesium, e.g., magnesium salts.

In one embodiment macronutrients are selected from the group comprising CaCl₂, NH₄Cl, KCl, MgSO₄, K₂SO₄, K₂HPO₄, KH₂PO₄, (NH₄)₂HPO₄, NH₄H₂PO₄, NH₄NO₃, Mg(NO₃)₂, Ca(NO₃)₂, Fe(NO₃)₂, FeSO₄, K₂SO₄*2 MgSO₄.

In another embodiment macronutrients are selected from the group comprising CaCl₂, MgCl₂, NH₄Cl, KCl, CaSO₄, (NH₄)₂SO₄, MgSO₄, K₂SO₄, K₂HPO₄, KH₂PO₄, (NH₄)₂HPO₄, NH₄H₂PO₄, NH₄NO₃.

Micronutrients are selected from the group comprising boron, e.g., boronic acid or borates chlorine, e.g., chlorides, iron, e.g., iron salts, manganese, e.g., manganese salts, zinc, e.g., zinc salts, copper, e.g., copper salts, molybdenum, e.g., molybdenum salts, nickel, e.g., nickel salts and cobalt, e.g., cobalt salts.

Micronutrients are selected from the group comprising H₃BO₃, Na₂MoO₄, NiCl₂, ZnCl₂, CuCl₂, CoCl₂, MnCl₂, MnSO₄, ZnSO₄, NiSO₄, CoSO₄, CuSO₄, ZnCO₃, CuCO₃, CoCO₃, MnCO₃, Mn₃(PO₄)₂, Cu₃(PO₄)₂, Ni₃(PO₄)₂, Co₃(PO₄)₂, Ni₃(PO₄)₂, Zn₃(PO₄)₂, MnHPO₄, CuHPO₄, NiHPO₄, CoHPO₄, NiHPO₄, ZnHPO₄.

In one embodiment micronutrients are selected from the group comprising H₃BO₃, ZnSO₄, ZnCl₂, Na₂MoO₄, NiCl₂, CuSO₄, CoCl₂, MnSO₄.

If, in the context of this description, the description refers to antioxidants and/or nutrients, this includes in each case all customary derivatives, such as the esters and salts, and isomers, in particular optical isomers, in particular the commercially available form or forms. Salts and esters are agronomically acceptable salts and esters. If antioxidants and/or nutrients denotes an ester or salt, this in each case also comprises all other customary derivatives, such as other esters and salts, the free acids and neutral compounds, and isomers, in particular optical isomers, in particular the commercially available form or forms. The salts of antioxidants and/or nutrients used in the context of the present invention may be used in the form of the respective alkali metal salts, alkaline earth salts, ammonium salts, carbonate, hydrogen carbonate, chloride salts, sulfate salts, hydrogen phosphate salts, dihydrogen phosphate salts, nitrate salts. In one embodiment the free acid of antioxidants is preferred.

The effect of antioxidants and/or nutrients depends essentially on the time of application in relation to the developmental stage of the plant, and also on the amounts of antioxidants and/or nutrients applied to the plants or their environment and on the type of application.

Enhanced crop safety can be defined as uniform germination, seedling emergence, seedling vigor such as increased hypocotyl length, increased plant height, reduction in leaf deformity, decrease in necrotic lesions, and overall increased size of plant structures such as cotyledons, unifoliates and trifoliates as well as altered plant metabolism and gene expression. Enhanced crop safety may comprise effects including but not limited to a higher percentage of healthy area of leaves or cotyledons, an overall larger area of cotyledons, unifoliates and/or trifoliates, an increase of chlorophyll fluorescence, higher chlorophyll content, a decrease of reactive oxygen species (ROS), and increased protein content. The enhanced crop safety is measured typically in the presence of an active ingredient with a potential to have an impact on crop safety in certain crops at certain concentrations at certain life stages. Comparisons are made between plants treated with the active ingredient without the antioxidants and/or nutrients being present and plants treated with the active ingredient and the antioxidants and/or nutrients being present.

In one embodiment the amount of antioxidants and/or nutrients applied may be sufficient to provide at least one crop safety improving effect selected from the group consisting of a higher percentage of healthy area of leaves or cotyledons, an overall larger area of cotyledons, unifoliates and/or trifoliates, a higher chlorophyll fluorescence, a higher chlorophyll content, a lower amount of reactive oxygen species, or an overall higher amount of protein.

In one embodiment the amount of antioxidants applied may be sufficient to provide at least one crop safety improving effect selected from the group consisting of a higher percentage of healthy area of leaves or cotyledons, an overall larger area of cotyledons, unifoliates and/or trifoliates, a higher chlorophyll fluorescence, a higher chlorophyll content, a lower amount of reactive oxygen species, or an overall higher amount of protein.

In one embodiment the amount of nutrients applied may be sufficient to provide at least one crop safety improving effect selected from the group consisting of a higher percentage of healthy area of leaves or cotyledons, an overall larger area of cotyledons, unifoliates and/or trifoliates, a higher chlorophyll fluorescence, a higher chlorophyll content, a lower amount of reactive oxygen species, or an overall higher amount of protein.

The healthy area of cotyledons or leaves is assessed by visual inspection and quantitative analysis using an image based algorithm.

Early establishment is defined as the growth stages according to the BBCH scale from BBCH stage 00 until 13 (three leave stage).

Light adapted chlorophyll fluorescence (Fv′/Fm′) is measured as an indicator for plant stress as disclosed in Maxwell K., Johnson G. N, “Chlorophyll Fluorescence—A Practical Guide,” Journal of Experimental Botany, April 2000, vol. 51, no. 345, pp. 659-668.

Reactive Oxygen species as an indicator for plant stress is measured according to Jajics et al., Plants (Basel), September 2015, 4(3): 393-411.

All plants and plant parts can be treated. By plants is meant all plants and plant populations such as desirable and undesirable wild plants, cultivars and plant varieties (whether or not protectable by plant variety or plant breeder's rights). Cultivars and plant varieties can be plants obtained by conventional propagation and breeding methods which can be assisted or supplemented by one or more biotechnological methods such as by use of double haploids, protoplast fusion, random and directed mutagenesis, molecular or genetic markers or by bioengineering and genetic engineering methods. By plant parts is meant all above ground and below ground parts and organs of plants such as shoot, leaf, blossom and root, whereby for example leaves, needles, stems, branches, blossoms, fruiting bodies, fruits and seed as well as roots, corms and rhizomes are listed. Crops and vegetative and generative propagating material, for example cuttings, corms, rhizomes, runners, whole seedlings and seeds also belong to plant parts.

Plants which can be treated in accordance with the invention include the following main crop plants: maize, soya bean, alfalfa, cotton, sunflower, Brassica oil seeds such as Brassica napus (e.g., canola, rapeseed), Brassica rapa, B. juncea (e.g., (field) mustard) and Brassica carinata, Arecaceae sp. (e.g., oilpalm, coconut), rice, wheat, sugar beet, sugar cane, oats, rye, barley, millet and sorghum, triticale, flax, nuts, grapes and vine and various fruit and vegetables from various botanic taxa, e.g., Rosaceae sp. (e.g., pome fruits such as apples and pears, but also stone fruits such as apricots, cherries, almonds, plums and peaches, and berry fruits such as strawberries, raspberries, red and black currant and gooseberry), Ribesioidae sp., Juglandaceae sp., Betulaceae sp., Anacardiaceae sp., Fagaceae sp., Moraceae sp., Oleaceae sp. (e.g., olive tree), Actinidaceae sp., Lauraceae sp. (e.g., avocado, cinnamon, camphor), Musaceae sp. (e.g., banana trees and plantations), Rubiaceae sp. (e.g., coffee), Theaceae sp. (e.g., tea), Sterculiceae sp., Rutaceae sp. (e.g., lemons, oranges, mandarins and grapefruit); Solanaceae sp. (e.g., tomatoes, potatoes, peppers, capsicum, aubergines, tobacco), Liliaceae sp., Compositae sp. (e.g., lettuce, artichokes and chicory—including root chicory, endive or common chicory), Umbelliferae sp. (e.g., carrots, parsley, celery and celeriac), Cucurbitaceae sp. (e.g., cucumbers—including gherkins, pumpkins, watermelons, calabashes and melons), Alliaceae sp. (e.g., leeks and onions), Cruciferae sp. (e.g., white cabbage, red cabbage, broccoli, cauliflower, Brussels sprouts, pak choi, kohlrabi, radishes, horseradish, cress and chinese cabbage), Leguminosae sp. (e.g., peanuts, peas, lentils and beans—e.g., common beans and broad beans), Chenopodiaceae sp. (e.g., Swiss chard, fodder beet, spinach, beetroot), Linaceae sp. (e.g., hemp), Cannabeacea sp. (e.g., cannabis), Malvaceae sp. (e.g., okra, cocoa), Papaveraceae (e.g., poppy), Asparagaceae (e.g., asparagus); useful plants and ornamental plants in the garden and woods including turf, lawn, grass and Stevia rebaudiana; and in each case genetically modified types of these plants.

In one embodiment plants to be treated are soybean, corn, cotton, oilseeds, in particular winter or spring oilseed rape, canola, vegetables, in particular those of the Solanaceae family like tomatoes, potatoes, peppers, capsicum, aubergines, cucurbits like cucumbers, squashes, melons, pumpkins, tobacco, rice, wheat, in particular spring wheat, winter wheat, Durum, oats, rye, barley, millet and sorghum, triticale, berries, e.g., strawberry, raspberry, blueberry, blackberry, gooseberry, red and black currant; stonefruit e.g., plum, cherry, apricot, peach, nectarine, mango, or other fruit e.g., persimmons.

In another embodiment plants are soybeans, cucurbits like cucumbers, squashes, melons, pumpkins.

Soybean varieties are divided into groups according to their relative times of maturity. An understanding of soybean relative maturity is important for growers to select the varieties best adapted to their production areas. It is best to pick a variety with sufficient maturity to maximize vegetative growth and thus node production prior to entering reproductive stages, however, planting a variety that does not flower soon enough may result in crop losses due to late season dry weather or early frost. (http://igrow.org/news/soybean-physiology-relative-maturity-explained/). Soybean varieties are therefore divided into maturity groups (MG) according to their relative times of maturity. MG are designated using Roman numerals from 0 (very short-season) to X for varieties developed for very warm climates with shorter days during growing season. An additional decimal can be added to denote gradations. The MG is assigned by the breeder and naming systems will include the MG number as part of the name MG 0 will be planted in northeastern regions of the United States while MG VI is the MG found in the southern soybean growing areas in the U.S. In Brazil due to is geographic position south of the 0 degree latitude MG 9 and 10 are found in the northern provinces of Brazil, while MG 5 to 6 is found around 30 degrees latitude in the southern region of Brazil.

As already mentioned above, it is possible to treat all plants and their parts in accordance with the invention. In a preferred embodiment, wild plant species and plant cultivars, or those obtained by conventional biological breeding methods, such as crossing or protoplast fusion, and also parts thereof, are treated. In a further preferred embodiment, transgenic plants and plant cultivars obtained by genetic engineering methods, if appropriate in combination with conventional methods (Genetically Modified Organisms), and parts thereof are treated. The terms “parts” or “parts of plants” or “plant parts” have been explained above. More preferably, plants of the plant cultivars which are commercially available or are in use are treated in accordance with the invention. Plant cultivars are understood to mean plants which have new properties (“traits”) and have been obtained by conventional breeding, by mutagenesis or by recombinant DNA techniques. They can be cultivars, varieties, bio- or genotypes.

The method of treatment according to the invention can be used in the treatment of genetically modified organisms (GMOs), e.g., plants or seeds. Genetically modified plants (or transgenic plants) are plants of which a heterologous gene has been stably integrated into genome. The expression “heterologous gene” essentially means a gene which is provided or assembled outside the plant and when introduced in the nuclear, chloroplastic or mitochondrial genome gives the transformed plant new or improved agronomic or other properties by expressing a protein or polypeptide of interest or by downregulating or silencing other gene(s) which are present in the plant (using for example, antisense technology, cosuppression technology, RNA interference—RNAi—technology or microRNA—miRNA—technology). A heterologous gene that is located in the genome is also called a transgene. A transgene that is defined by its particular location in the plant genome is called a transformation or transgenic event. In one embodiment crops are of interest being tolerant to herbicides, e.g., to glyphosate, glufosinate, sulfonylureas, 2,4-D, dicamba.

Plants and plant cultivars which are preferably to be treated according to the invention include all plants which have genetic material which impart particularly advantageous, useful traits to these plants (whether obtained by breeding and/or biotechnological means).

Plants and plant cultivars which are also preferably to be treated according to the invention are resistant against one or more biotic stresses, i.e., said plants show a better defense against animal and microbial pests, such as against nematodes, insects, mites, phytopathogenic fungi, bacteria, viruses and/or viroids.

Plants and plant cultivars which may also be treated according to the invention are those plants which are resistant to one or more abiotic stresses. Abiotic stress conditions may include, for example, drought, cold temperature exposure, heat exposure, osmotic stress, flooding, increased soil salinity, increased mineral exposure, ozone exposure, high light exposure, limited availability of nitrogen nutrients, limited availability of phosphorus nutrients, shade avoidance.

Plants and plant cultivars which may also be treated according to the invention, are those plants characterized by enhanced yield characteristics. Increased yield in said plants can be the result of, for example, improved plant physiology, growth and development, such as water use efficiency, water retention efficiency, improved nitrogen use, enhanced carbon assimilation, improved photosynthesis, increased germination efficiency and accelerated maturation. Yield can furthermore be affected by improved plant architecture (under stress and non-stress conditions), including but not limited to, early flowering, flowering control for hybrid seed production, seedling vigor, plant size, leaf area, Crop growth rate, Net Assimilation rate, Leaf area duration, internode number and distance, root growth, nodulation, nitrogen fixation, seed size, fruit size, pod size, pod or ear number, seed number per pod or ear, seed mass, enhanced seed filling, reduced seed dispersal, reduced pod dehiscence and lodging resistance. Further yield traits include seed composition, such as carbohydrate content and composition for example cotton or starch, protein content, oil content and composition, nutritional value, reduction in anti-nutritional compounds, improved processability and better storage stability.

Plants that may be treated according to the invention are hybrid plants that already express the characteristic of heterosis or hybrid vigor which results in generally higher yield, vigor, health and resistance towards biotic and abiotic stresses).

Plants or plant cultivars (obtained by plant biotechnology methods such as genetic engineering) which may be treated according to the invention are herbicide-tolerant plants, i.e., plants made tolerant to one or more given herbicides. Such plants can be obtained either by genetic transformation, or by selection of plants containing a mutation imparting such herbicide tolerance.

Plants or plant cultivars (obtained by plant biotechnology methods such as genetic engineering) which may also be treated according to the invention are insect-resistant transgenic plants, i.e., plants made resistant to attack by certain target insects. Such plants can be obtained by genetic transformation, or by selection of plants containing a mutation imparting such insect resistance.

Plants or plant cultivars (obtained by plant biotechnology methods such as genetic engineering) which may also be treated according to the invention are tolerant to abiotic stresses. Such plants can be obtained by genetic transformation, or by selection of plants containing a mutation imparting such stress resistance.

Plants or plant cultivars (obtained by plant biotechnology methods such as genetic engineering) which may also be treated according to the invention show altered quantity, quality and/or storage-stability of the harvested product and/or altered properties of specific ingredients of the harvested product.

Plants or plant cultivars (that can be obtained by plant biotechnology methods such as genetic engineering) which may also be treated according to the invention are plants, such as cotton plants, with altered fiber characteristics. Such plants can be obtained by genetic transformation, or by selection of plants contain a mutation imparting such altered fiber characteristics.

Plants or plant cultivars (that can be obtained by plant biotechnology methods such as genetic engineering) which may also be treated according to the invention are plants, such as oilseed rape or related Brassica plants, with altered oil profile characteristics. Such plants can be obtained by genetic transformation, or by selection of plants contain a mutation imparting such altered oil profile characteristics.

Plants or plant cultivars (that can be obtained by plant biotechnology methods such as genetic engineering) which may also be treated according to the invention are plants, such as oilseed rape or related Brassica plants, with altered seed shattering characteristics. Such plants can be obtained by genetic transformation, or by selection of plants contain a mutation imparting such altered seed shattering characteristics and include plants such as oilseed rape plants with delayed or reduced seed shattering.

Plants or plant cultivars (that can be obtained by plant biotechnology methods such as genetic engineering) which may also be treated according to the invention are plants, such as Tobacco plants, with altered post-translational protein modification patterns.

In one embodiment useful transgenic plants which may be treated according to the invention are plants containing transformation events, or a combination of transformation events, and that are listed for example in the databases for various national or regional regulatory agencies including Event 1143-14A (cotton, insect control, not deposited, described in WO 2006/128569); Event 1143-51B (cotton, insect control, not deposited, described in WO 2006/128570); Event 1445 (cotton, herbicide tolerance, not deposited, described in U.S. Patent Application Publication No. 2002/120964 or WO 2002/034946); Event 17053 (rice, herbicide tolerance, deposited as PTA-9843, described in WO 2010/117737); Event 17314 (rice, herbicide tolerance, deposited as PTA-9844, described in WO 2010/117735); Event 281-24-236 (cotton, insect control—herbicide tolerance, deposited as PTA-6233, described in WO 2005/103266 or U.S. Patent Application Publication No. 2005/216969); Event 3006-210-23 (cotton, insect control—herbicide tolerance, deposited as PTA-6233, described in U.S. Patent Application Publication No. 2007/143876 or WO 2005/103266); Event 3272 (corn, quality trait, deposited as PTA-9972, described in WO 2006/098952 or U.S. Patent Application Publication No. 2006/230473); Event 40416 (corn, insect control—herbicide tolerance, deposited as ATCC PTA-11508, described in WO 2011/075593); Event 43A47 (corn, insect control—herbicide tolerance, deposited as ATCC PTA-11509, described in WO 2011/075595); Event 5307 (corn, insect control, deposited as ATCC PTA-9561, described in WO 2010/077816); Event ASR-368 (bent grass, herbicide tolerance, deposited as ATCC PTA-4816, described in U.S. Patent Application Publication No. 2006/162007 or WO 2004/053062); Event B16 (corn, herbicide tolerance, not deposited, described in U.S. Patent Application Publication No. 2003/126634); Event BPS-CV127-9 (soybean, herbicide tolerance, deposited as NCIMB No. 41603, described in WO 2010/080829); Event CE43-67B (cotton, insect control, deposited as DSM ACC2724, described in U.S. Patent Application Publication No. 2009/217423 or WO 2006/128573); Event CE44-69D (cotton, insect control, not deposited, described in U.S. Patent Application Publication No. 2010/0024077); Event CE44-69D (cotton, insect control, not deposited, described in WO 2006/128571); Event CE46-02A (cotton, insect control, not deposited, described in WO 2006/128572); Event COT102 (cotton, insect control, not deposited, described in U.S. Patent Application Publication No. 2006/130175 or WO 2004/039986); Event COT202 (cotton, insect control, not deposited, described in US 2007/067868 or WO 2005/054479); Event COT203 (cotton, insect control, not deposited, described in WO 2005/054480); Event DAS40278 (corn, herbicide tolerance, deposited as ATCC PTA-10244, described in WO 2011/022469); Event DAS-59122-7 (corn, insect control - herbicide tolerance, deposited as ATCC PTA 11384, described in U.S. Patent Application Publication No. 2006/070139); Event DAS-59132 (corn, insect control—herbicide tolerance, not deposited, described in WO 2009/100188); Event DAS68416 (soybean, herbicide tolerance, deposited as ATCC PTA-10442, described in WO 2011/066384 or WO 2011/066360); Event DP-098140-6 (corn, herbicide tolerance, deposited as ATCC PTA-8296, described in U.S. Patent Application Publication No. 2009/137395 or WO 2008/112019); Event DP-305423-1 (soybean, quality trait, not deposited, described in U.S. Patent Application Publication No. 2008/312082 or WO 2008/054747); Event DP-32138-1 (corn, hybridization system, deposited as ATCC PTA-9158, described in U.S. Patent Application Publication No. 2009/0210970 or WO 2009/103049); Event DP-356043-5 (soybean, herbicide tolerance, deposited as ATCC PTA-8287, described in U.S. Patent Application Publication No. 2010/0184079 or WO 2008/002872); Event EE-1 (brinjal, insect control, not deposited, described in WO 2007/091277); Event FI117 (corn, herbicide tolerance, deposited as ATCC 209031, described in U.S. Patent Application Publication No. 2006/059581 or WO 1998/044140); Event GA21 (corn, herbicide tolerance, deposited as ATCC 209033, described in U.S. Patent Application Publication No. 2005/086719 or WO 1998/044140); Event GG25 (corn, herbicide tolerance, deposited as ATCC 209032, described in U.S. Patent Application Publication No. 2005/188434 or WO 1998/044140); Event GHB119 (cotton, insect control—herbicide tolerance, deposited as ATCC PTA-8398, described in WO 2008/151780); Event GHB614 (cotton, herbicide tolerance, deposited as ATCC PTA-6878, described in U.S. Patent Application Publication No. 2010/050282 or WO 2007/017186); Event GJ11 (corn, herbicide tolerance, deposited as ATCC 209030, described in U.S. Patent Application Publication No. 2005/188434 or WO 1998/044140); Event GM RZ13 (sugar beet, virus resistance , deposited as NCIMB-41601, described in WO 2010/076212); Event H7-1 (sugar beet, herbicide tolerance, deposited as NCIMB 41158 or NCIMB 41159, described in U.S. Patent Application Publication No. 2004/172669 or WO 2004/074492); Event JOPLIN1 (wheat, disease tolerance, not deposited, described in U.S. Patent Application Publication No. 2008/064032); Event LL27 (soybean, herbicide tolerance, deposited as NCIMB41658, described in WO 2006/108674 or U.S. Patent Application Publication No. 2008/320616); Event LL55 (soybean, herbicide tolerance, deposited as NCIMB 41660, described in WO 2006/108675 or U.S. Patent Application Publication No. 2008/196127); Event LLcotton25 (cotton, herbicide tolerance, deposited as ATCC PTA-3343, described in WO 2003/013224 or U.S. Patent Application Publication No. 2003/097687); Event LLRICE06 (rice, herbicide tolerance, deposited as ATCC-23352, described in U.S. Pat. No. 6,468,747 or WO 2000/026345); Event LLRICE601 (rice, herbicide tolerance, deposited as ATCC PTA-2600, described in U.S. Patent Application Publication No. 2008/2289060 or WO 2000/026356); Event LY038 (corn, quality trait, deposited as ATCC PTA-5623, described in U.S. Patent Application Publication No. 2007/028322 or WO 2005/061720); Event MIR162 (corn, insect control, deposited as PTA-8166, described in U.S. Patent Application Publication No. 2009/300784 or WO 2007/142840); Event MIR604 (corn, insect control, not deposited, described in U.S. Patent Application Publication No. 2008/167456 or WO 2005103301); Event MON15985 (cotton, insect control, deposited as ATCC PTA-2516, described in U.S. Patent Application Publication No. 2004/250317 or WO 2002/100163); Event MON810 (corn, insect control, not deposited, described in U.S. Patent Application Publication No. 2002/102582); Event MON863 (corn, insect control, deposited as ATCC PTA-2605, described in WO 2004/011601 or U.S. Patent Application Publication No. 2006/095986); Event MON87427 (corn, pollination control, deposited as ATCC PTA-7899, described in WO 2011/062904); Event MON87460 (corn, stress tolerance, deposited as ATCC PTA-8910, described in WO 2009/111263 or U.S. Patent Application Publication No. 2011/0138504); Event MON87701 (soybean, insect control, deposited as ATCC PTA-8194, described in U.S. Patent Application Publication No. 2009/130071 or WO 2009/064652); Event MON87705 (soybean, quality trait—herbicide tolerance, deposited as ATCC PTA-9241, described in U.S. Patent Application Publication No. 2010/080887 or WO 2010/037016); Event MON87708 (soybean, herbicide tolerance, deposited as ATCC PTA9670, described in WO 2011/034704); Event MON87754 (soybean, quality trait, deposited as ATCC PTA-9385, described in WO 2010/024976); Event MON87769 (soybean, quality trait, deposited as ATCC PTA-8911, described in U.S. Patent Application Publication No. 2011/0067141 or WO 2009/102873); Event MON88017 (corn, insect control—herbicide tolerance, deposited as ATCC PTA-5582, described in U.S. Patent Application Publication No. 2008/028482 or WO 2005/059103); Event MON88913 (cotton, herbicide tolerance, deposited as ATCC PTA-4854, described in WO 2004/072235 or U.S. Patent Application Publication No. 2006/059590); Event MON89034 (corn, insect control, deposited as ATCC PTA-7455, described in WO 2007/140256 or U.S. Patent Application Publication No. 2008/260932); Event MON89788 (soybean, herbicide tolerance, deposited as ATCC PTA-6708, described in U.S. Patent Application Publication No. 2006/282915 or WO 2006/130436); Event MS11 (oilseed rape, pollination control—herbicide tolerance, deposited as ATCC PTA-850 or PTA-2485, described in WO 2001/031042); Event MS8, (oilseed rape, pollination control—herbicide tolerance, deposited as ATCC PTA-730, described in WO 2001/041558 or U.S. Patent Application Publication No. 2003/188347); Event NK603 (corn, herbicide tolerance, deposited as ATCC PTA-2478, described in U.S. Patent Application Publication No. 2007/292854); Event PE-7 (rice, insect control, not deposited, described in W02008/114282); Event RF3, (oilseed rape, pollination control—herbicide tolerance, deposited as ATCC PTA-730, described in WO 2001/041558 or U.S. Patent Application Publication No. 2003/188347); Event RT73 (oilseed rape, herbicide tolerance, not deposited, described in WO 2002/036831 or U.S. Patent Application Publication No. 2008/070260); Event T227-1 (sugar beet, herbicide tolerance, not deposited, described in WO 2002/44407 or U.S. Patent Application Publication No. 2009/265817); Event T25 (corn, herbicide tolerance, not deposited, described in U.S. Patent Application Publication No. 2001/029014 or WO 2001/051654); Event T304-40 (cotton, insect control—herbicide tolerance, deposited as ATCC PTA-8171, described in U.S. Patent Application Publication No. 2010/077501 or WO 2008/122406); Event T342-142 (cotton, insect control, not deposited, described in WO 2006/128568); Event TC1507 (corn, insect control -herbicide tolerance, not deposited, described in U.S. Patent Application Publication No. 2005/039226 or WO 2004/099447); Event VIP1034 (corn, insect control—herbicide tolerance, deposited as ATCC PTA-3925, described in WO 2003/052073), Event 32316 (corn, insect control-herbicide tolerance, deposited as PTA-11507, described in WO 2011/153186A1), Event 4114 (corn, insect control-herbicide tolerance, deposited as PTA-11506, described in WO 2011/084621), event EE-GM3/FG72 (soybean, herbicide tolerance, ATCC Accession No. PTA-11041, WO 2011/063413 A2), event DAS-68416-4 (soybean, herbicide tolerance, ATCC Accession No. PTA-10442, WO 2011/066360A1), event DAS-68416-4 (soybean, herbicide tolerance, ATCC Accession No. PTA-10442, WO 2011/066384 A1), event DP-040416-8 (corn, insect control, ATCC Accession No. PTA-11508, WO 2011/075593 A1), event DP-043A47-3 (corn, insect control, ATCC Accession No. PTA-11509, WO 2011/075595 A1), event DP-004114-3 (corn, insect control, ATCC Accession No. PTA-11506, WO 2011/084621 A1), event DP-032316-8 (corn, insect control, ATCC Accession No. PTA-11507, WO 2011/084632 A1), event MON-88302-9 (oilseed rape, herbicide tolerance, ATCC Accession No. PTA-10955, WO 2011/153186A1), event DAS-21606-3 (soybean, herbicide tolerance, ATCC Accession No. PTA-11028, WO 2012/033794A2), event MON-87712-4 (soybean, quality trait, ATCC Accession No. PTA-10296, WO 2012/051199A2), event DAS-44406-6 (soybean, stacked herbicide tolerance, ATCC Accession No. PTA-11336, WO 2012/075426A1), event DAS-14536-7 (soybean, stacked herbicide tolerance, ATCC Accession No. PTA-11335, WO 2012/075429A1), event SYN-000H2-5 (soybean, herbicide tolerance, ATCC Accession No. PTA-11226, WO 2012/082548A2), event DP-061061-7 (oilseed rape, herbicide tolerance, no deposit number available, WO 2012071039A1), event DP-073496-4 (oilseed rape, herbicide tolerance, no deposit number available, U.S. Patent Application Publication No. 2012/131692), event 8264.44.06.1 (soybean, stacked herbicide tolerance, Accession No. PTA-11336, WO2012075426A2), event 8291.45.36.2 (soybean, stacked herbicide tolerance, Accession No. PTA-11335, WO2012075429A2).

### Mixtures

Antioxidants may be used as such or in formulations thereof and may be mixed with known fungicides, bactericides, acaricides, nematicides or insecticides to provide agricultural compositions. Antioxidants may also be used in formulations comprising biological control agents.

Useful mixing partners include, for example, known fungicides, insecticides, acaricides, nematicides or else bactericides (see also Pesticide Manual, 14th ed.)

A mixture with other known active ingredients, such as herbicides, or with fertilizers and growth regulators, safeners and/or semiochemicals, is also possible.

In one embodiment a composition comprises antioxidants and/or nutrients and at least one other agrochemically active ingredient comprising being Fluopyram, Clothianidin, Penflufen, Prothioconazole, Metalaxyl, Tebuconazole or Flupyradifurone.

In one embodiment a composition comprises antioxidants and/or nutrients and Fluopyram.

In one embodiment a composition comprises antioxidants and/or nutrients and Clothianidin.

In one embodiment a composition comprises antioxidants and/or nutrients and Penflufen.

In one embodiment a composition comprises antioxidants and/or nutrients and Prothioconazole.

In one embodiment a composition comprises antioxidants and/or nutrients and Metalaxyl.

In one embodiment a composition comprises antioxidants and/or nutrients and Flupyradifurone.

In one embodiment a composition comprises antioxidants and/or nutrients and Tebuconazole.

In one embodiment a composition comprises antioxidants and/or nutrients and at least one other agrochemically insecticidal active ingredient comprising Flupyradifurone, Oxamyl, Chlorpyrifos-methyl, Bifenthrin, Lambda-Cyhalothrin, Tefluthrin, Acetamiprid, Clothianidin, Dinotefuran, Imidacloprid, Nitenpyram, Thiacloprid, Sulfoxaflor, Fipronil, or Ethiprole.

In one embodiment antioxidants and/or nutrients may be mixed in tank mixes with at least one active ingredient being Fluopyram, Clothianidin, Penflufen, Prothioconazole, Metalaxyl, Tebuconazole or Flupyradifurone.

In one embodiment antioxidants and/or nutrients may be mixed in tank mixes with at least one insecticidal active ingredient being Flupyradifurone, Oxamyl, Chlorpyrifos-methyl, Bifenthrin, Lambda-Cyhalothrin, Tefluthrin, Acetamiprid, Clothianidin, Dinotefuran, Imidacloprid, Nitenpyram, Thiacloprid, Sulfoxaflor, Fipronil or Ethiprole.

In one embodiment antioxidants and/or nutrients may be applied sequentially with at least one active ingredient being Fluopyram, Clothianidin, Penflufen, Prothioconazole, Metalaxyl, Tebuconazole or Flupyradifurone.

In one embodiment antioxidants and/or nutrients may be applied sequentially with at least one insecticidal active ingredient being Flupyradifurone, Oxamyl, Chlorpyrifos-methyl, Bifenthrin, Lambda-Cyhalothrin, Tefluthrin, Acetamiprid, Clothianidin, Dinotefuran, Imidacloprid, Nitenpyram, Thiacloprid, Sulfoxaflor, Fipronil or Ethiprole.

In one embodiment antioxidants and/or nutrients may be applied sequentially with at least one active ingredient being Fluopyram.

In one embodiment antioxidants and/or nutrients may be applied sequentially with at least one active ingredient being Fluopyram, Clothianidin, Penflufen, Prothioconazole, Metalaxyl, Tebuconazole or Flupyradifurone.

In one embodiment antioxidants and/or nutrients may be applied sequentially with at least one active ingredient being Fluopyram.

In one embodiment antioxidants and/or nutrients may be applied sequentially with at least one active ingredient being Fluopyram, Clothianidin, Penflufen, Prothioconazole, Metalaxyl, Tebuconazole or Flupyradifurone.

In one embodiment antioxidants and/or nutrients may be applied sequentially with at least one active ingredient being Fluopyram.

In one embodiment a composition comprises antioxidants and at least one other agrochemically active ingredient comprising being Fluopyram, Clothianidin, Penflufen, Prothioconazole, Metalaxyl, Tebuconazole or Flupyradifurone.

In one embodiment a composition comprises antioxidants and Fluopyram.

In one embodiment a composition comprises antioxidants and Clothianidin.

In one embodiment a composition comprises antioxidants and Penflufen.

In one embodiment a composition comprises antioxidants and Prothioconazole.

In one embodiment a composition comprises antioxidants and Metalaxyl.

In one embodiment a composition comprises antioxidants and Flupyradifurone.

In one embodiment a composition comprises antioxidants and Tebuconazole.

In one embodiment antioxidants may be mixed in tank mixes with at least one active ingredient being Fluopyram, Clothianidin, Penflufen, Prothioconazole, Metalaxyl, Tebuconazole or Flupyradifurone.

In one embodiment antioxidants may be applied sequentially with at least one active ingredient being Fluopyram, Clothianidin, Penflufen, Prothioconazole, Metalaxyl, Tebuconazole or Flupyradifurone.

In one embodiment antioxidants may be applied sequentially with at least one active ingredient being Fluopyram.

In one embodiment antioxidants may be applied sequentially with at least one active ingredient being Fluopyram, Clothianidin, Penflufen, Prothioconazole, Metalaxyl, Tebuconazole or Flupyradifurone.

In one embodiment antioxidants may be applied sequentially with at least one active ingredient being Fluopyram.

In one embodiment antioxidants may be applied sequentially with at least one active ingredient being Fluopyram, Clothianidin, Penflufen, Prothioconazole, Metalaxyl, Tebuconazole or Flupyradifurone.

In one embodiment antioxidants may be applied sequentially with at least one active ingredient being Fluopyram.

In one embodiment a composition comprises nutrients and at least one other agrochemically active ingredient comprising being Fluopyram, Clothianidin, Penflufen, Prothioconazole, Metalaxyl, Tebuconazole or Flupyradifurone.

In one embodiment a composition comprises nutrients and Fluopyram.

In one embodiment a composition comprises nutrients and Clothianidin.

In one embodiment a composition comprises nutrients and Penflufen.

In one embodiment a composition comprises nutrients and Prothioconazole.

In one embodiment a composition comprises nutrients and Metalaxyl.

In one embodiment a composition comprises nutrients and Flupyradifurone.

In one embodiment a composition comprises nutrients and Tebuconazole.

In one embodiment nutrients may be mixed in tank mixes with at least one active ingredient being Fluopyram, Clothianidin, Penflufen, Prothioconazole, Metalaxyl, Tebuconazole or Flupyradifurone.

In one embodiment nutrients may be applied sequentially with at least one active ingredient being Fluopyram, Clothianidin, Penflufen, Prothioconazole, Metalaxyl, Tebuconazole or Flupyradifurone.

In one embodiment nutrients may be applied sequentially with at least one active ingredient being Fluopyram.

In one embodiment nutrients may be applied sequentially with at least one active ingredient being Fluopyram, Clothianidin, Penflufen, Prothioconazole, Metalaxyl, Tebuconazole or Flupyradifurone.

In one embodiment nutrients may be applied sequentially with at least one active ingredient being Fluopyram.

In one embodiment nutrients may be applied sequentially with at least one active ingredient being Fluopyram, Clothianidin, Penflufen, Prothioconazole, Metalaxyl, Tebuconazole or Flupyradifurone.

In one embodiment nutrients may be applied sequentially with at least one active ingredient being Fluopyram.

In one embodiment antioxidants and/or nutrients may be mixed in tank mixes with at least one active ingredient being Fluopyram, Clothianidin, Penflufen, Prothioconazole, Metalaxyl, Tebuconazole or Flupyradifurone for soil applications.

In one embodiment antioxidants and/or nutrients may be applied sequentially with at least one active ingredient being Fluopyram, Clothianidin, Penflufen, Prothioconazole, Metalaxyl, Tebuconazole or Flupyradifurone in soil applications.

In one embodiment antioxidants and/or nutrients may be applied sequentially with at least one active ingredient being Fluopyram in soil applications.

In one embodiment antioxidants and/or nutrients may be applied sequentially with at least one active ingredient being Fluopyram, Clothianidin, Penflufen, Prothioconazole, Metalaxyl, Tebuconazole or Flupyradifurone in soil applications.

In one embodiment antioxidants and/or nutrients may be applied sequentially with at least one active ingredient being Fluopyram in soil applications.

In one embodiment antioxidants and/or nutrients may be applied sequentially with at least one active ingredient being Fluopyram, Clothianidin, Penflufen, Prothioconazole, Metalaxyl, Tebuconazole or Flupyradifurone in soil applications.

In one embodiment antioxidants and/or nutrients may be applied sequentially with at least one active ingredient being Fluopyram in soil applications.

In one embodiment antioxidants may be mixed in tank mixes with at least one active ingredient being Fluopyram, Clothianidin, Penflufen, Prothioconazole, Metalaxyl, Tebuconazole or Flupyradifurone for soil applications.

In one embodiment antioxidants may be applied sequentially with at least one active ingredient being Fluopyram, Clothianidin, Penflufen, Prothioconazole, Metalaxyl, Tebuconazole or Flupyradifurone in soil applications.

In one embodiment antioxidants may be applied sequentially with at least one active ingredient being Fluopyram in soil applications.

In one embodiment antioxidants may be applied sequentially with at least one active ingredient being Fluopyram, Clothianidin, Penflufen, Prothioconazole, Metalaxyl, Tebuconazole or Flupyradifurone in soil applications.

In one embodiment antioxidants may be applied sequentially with at least one active ingredient being Fluopyram in soil applications.

In one embodiment antioxidants may be applied sequentially with at least one active ingredient being Fluopyram, Clothianidin, Penflufen, Prothioconazole, Metalaxyl, Tebuconazole or Flupyradifurone in soil applications.

In one embodiment antioxidants may be applied sequentially with at least one active ingredient being Fluopyram in soil applications.

In one embodiment nutrients may be mixed in tank mixes with at least one active ingredient being Fluopyram, Clothianidin, Penflufen, Prothioconazole, Metalaxyl, Tebuconazole or Flupyradifurone for soil applications.

In one embodiment nutrients may be applied sequentially with at least one active ingredient being Fluopyram, Clothianidin, Penflufen, Prothioconazole, Metalaxyl, Tebuconazole or Flupyradifurone in soil applications.

In one embodiment nutrients may be applied sequentially with at least one active ingredient being Fluopyram in soil applications.

In one embodiment nutrients may be applied sequentially with at least one active ingredient being Fluopyram, Clothianidin, Penflufen, Prothioconazole, Metalaxyl, Tebuconazole or Flupyradifurone in soil applications.

In one embodiment nutrients may be applied sequentially with at least one active ingredient being Fluopyram in soil applications.

In one embodiment nutrients may be applied sequentially with at least one active ingredient being Fluopyram, Clothianidin, Penflufen, Prothioconazole, Metalaxyl, Tebuconazole or Flupyradifurone in soil applications.

In one embodiment nutrients may be applied sequentially with at least one active ingredient being Fluopyram in soil applications.

In one embodiment antioxidants and/or nutrients may be mixed in tank mixes with at least one active ingredient being Fluopyram, Clothianidin, Penflufen, Prothioconazole, Metalaxyl, Tebuconazole or Flupyradifurone for priming transplants.

In one embodiment antioxidants and/or nutrients may be applied sequentially with at least one active ingredient being Fluopyram, Clothianidin, Penflufen, Prothioconazole, Metalaxyl, Tebuconazole or Flupyradifurone for priming transplants.

In one embodiment antioxidants and/or nutrients may be applied sequentially with at least one active ingredient being Fluopyram for priming transplants.

In one embodiment antioxidants and/or nutrients may be applied sequentially with at least one active ingredient being Fluopyram, Clothianidin, Penflufen, Prothioconazole, Metalaxyl, Tebuconazole or Flupyradifurone for priming transplants.

In one embodiment antioxidants and/or nutrients may be applied sequentially with at least one active ingredient being Fluopyram for priming transplants.

In one embodiment antioxidants and/or nutrients may be applied sequentially with at least one active ingredient being Fluopyram, Clothianidin, Penflufen, Prothioconazole, Metalaxyl, Tebuconazole or Flupyradifurone for priming transplants.

In one embodiment antioxidants and/or nutrients may be applied sequentially with at least one active ingredient being Fluopyram for priming transplants.

In one embodiment antioxidants may be mixed in tank mixes with at least one active ingredient being Fluopyram, Clothianidin, Penflufen, Prothioconazole, Metalaxyl, Tebuconazole or Flupyradifurone for priming transplants.

In one embodiment antioxidants may be applied sequentially with at least one active ingredient being Fluopyram, Clothianidin, Penflufen, Prothioconazole, Metalaxyl, Tebuconazole or Flupyradifurone for priming transplants.

In one embodiment antioxidants may be applied sequentially with at least one active ingredient being Fluopyram for priming transplants.

In one embodiment antioxidants may be applied sequentially with at least one active ingredient being Fluopyram, Clothianidin, Penflufen, Prothioconazole, Metalaxyl, Tebuconazole or Flupyradifurone for priming transplants.

In one embodiment antioxidants may be applied sequentially with at least one active ingredient being Fluopyram for priming transplants.

In one embodiment antioxidants may be applied sequentially with at least one active ingredient being Fluopyram, Clothianidin, Penflufen, Prothioconazole, Metalaxyl, Tebuconazole or Flupyradifurone for priming transplants.

In one embodiment antioxidants may be applied sequentially with at least one active ingredient being Fluopyram for priming transplants.

In one embodiment nutrients may be mixed in tank mixes with at least one active ingredient being Fluopyram, Clothianidin, Penflufen, Prothioconazole, Metalaxyl or Flupyradifurone for priming transplants.

In one embodiment nutrients may be applied sequentially with at least one active ingredient being Fluopyram, Clothianidin, Penflufen, Prothioconazole, Metalaxyl, Tebuconazole or Flupyradifurone for priming transplants.

In one embodiment nutrients may be applied sequentially with at least one active ingredient being Fluopyram for priming transplants.

In one embodiment nutrients may be applied sequentially with at least one active ingredient being Fluopyram, Clothianidin, Penflufen, Prothioconazole, Metalaxyl, Tebuconazole or Flupyradifurone for priming transplants.

In one embodiment nutrients may be applied sequentially with at least one active ingredient being Fluopyram for priming transplants.

In one embodiment nutrients may be applied sequentially with at least one active ingredient being Fluopyram, Clothianidin, Penflufen, Prothioconazole, Metalaxyl, Tebuconazole or Flupyradifurone for priming transplants.

In one embodiment nutrients may be applied sequentially with at least one active ingredient being Fluopyram for priming transplants.

The invention furthermore includes a method for treating seed.

A further aspect of the present invention relates in particular to seeds (dormant, primed, pregerminated or even with emerged roots and leaves) treated with antioxidants. The inventive seeds are used in methods for improving crop safety in seeds and emerged plants from the seeds.

Antioxidants and/or nutrients may be suitable for the treatment of seeds and young seedlings. The roots and shoots of the growing plant are particularly sensitive to compounds causing problem in crop safety. Accordingly, there is great interest in improving crop safety in the seed and the germinating plant by using appropriate compositions.

It is also desirable to optimize the amount of antioxidants and/or nutrients used so as to provide the best possible improvement of crop safety for the seeds, the germinating plants and emerged seedlings, but without damaging the plants themselves by antioxidants and/or nutrients used. In particular, methods for the treatment of seed should also take into consideration the intrinsic phenotypes of transgenic plants in order to achieve optimum protection of the seed and the germinating plant.

In one embodiment a method for improving crop safety in seeds, germinating plants and emerged seedlings is described by treating the seeds with an inventive composition. The invention also relates to the use of the compositions for treating seeds for improving crop safety in the seeds, the germinating plants and emerged seedlings. The invention further relates to seeds which has been treated with a composition comprising antioxidants and/or nutrients for improving crop safety.

One of the advantages of the present invention is that the treatment of the seeds with these compositions not only may improve crop safety in the seed itself, but also may improve crop safety in the resulting plants after emergence. In this way, the immediate treatment of the crop at the time of sowing or shortly thereafter protect plants as well as seed treatment in prior to sowing. It is likewise considered to be advantageous that antioxidants and/or nutrients or compositions comprising antioxidants and/or nutrients may be used especially also for transgenic seed, in which case the plant which grows from this seed is capable of expressing a protein which acts against pests, herbicidal damage or abiotic stress.

Antioxidants may be suitable for improving crop safety in seed of any plant variety which is used in agriculture, in the greenhouse production, in forests or in horticulture.

More particularly, the seed is that of cereals (such as wheat, barley, rye, millet and oats), oilseed rape, maize, cotton, soybean, rice, potatoes, sunflower, beans, coffee, beet (e.g., sugar beet and fodder beet), peanut, vegetables (such as tomato, cucumber, onions and lettuce), lawns and ornamental plants. Of particular significance is the treatment of the seed of wheat, soybean, oilseed rape, maize and rice.

As also described below, the treatment of transgenic seed with antioxidants and/or nutrients may be of particular significance. This refers to the seed of plants containing at least one heterologous gene which allows the expression of a polypeptide or protein, e.g., having insecticidal properties. These heterologous genes in transgenic seeds may originate, for example, from microorganisms of the species Bacillus, Rhizobium, Pseudomonas, Serratia, Trichoderma, Clavibacter, Glomus or Gliocladium. These heterologous genes preferably originates from Bacillus sp., in which case the gene product is effective against the European corn borer and/or the Western corn rootworm. Particularly preferably, the heterologous genes originate from Bacillus thuringiensis.

The composition is applied to seeds either alone or in a suitable formulation. Preferably, the seed is treated in a state in which it is sufficiently stable for no damage to occur in the course of treatment. In general, seeds can be treated at any time between harvest and sometime after sowing. It is customary to use seed which has been separated from the plant and freed from cobs, shells, stalks, coats, hairs or the flesh of the fruits. For example, it is possible to use seed which has been harvested, cleaned and dried down to a moisture content of less than 15% by weight. Alternatively, it is also possible to use seed which, after drying, for example, has been treated with water and then dried again, or seeds just after priming, or seeds stored in primed conditions or pre-germinated seeds, or seeds sown on nursery trays, tapes or paper.

When treating the seeds, it generally has to be ensured that the amount of the composition applied to the seed and/or the amount of further additives is selected such that the germination of the seed is not impaired, or that the resulting plant is not damaged.

Antioxidants may be applied directly, i.e., without containing any other components and without having been diluted. In general, it is preferable to apply the compositions to the seed in the form of a suitable formulation. Suitable formulations and methods for seed treatment are known to those skilled in the art. Antioxidants may be converted to the customary formulations relevant to on-seed applications, such as solutions, emulsions, suspensions, powders, foams, slurries or combined with other coating compositions for seed, such as film forming materials, pelleting materials, fine iron or other metal powders, granules, coating material for inactivated seeds, and also ULV formulations.

These formulations are prepared in a known manner, by mixing antioxidants and/or nutrients with customary additives, for example customary extenders and solvents or diluents, dyes, wetting agents, dispersants, emulsifiers, antifoams, preservatives, secondary thickeners, adhesives, gibberellins, and also water.

Useful dyes which may be present in the seed dressing formulations usable in accordance with the invention are all dyes which are customary for such purposes. It is possible to use either pigments, which are sparingly soluble in water, or dyes, which are soluble in water. Examples include the dyes known by the names Rhodamine B, C.I. Pigment Red 112 and C.I. Solvent Red 1.

Useful wetting agents which may be present in the seed dressing formulations usable in accordance with the invention are all substances which promote wetting and which are conventionally used for the formulation of active agrochemical ingredients including plant growth regulators. Usable with preference are alkylnaphthalenesulphonates, such as diisopropyl-or diisobutylnaphthalenesulphonates.

Useful dispersants and/or emulsifiers which may be present in the seed dressing formulations usable in accordance with the invention are all nonionic, anionic and cationic dispersants conventionally used for the formulation of active agrochemical ingredients including plant growth regulators. Usable with preference are nonionic or anionic dispersants or mixtures of nonionic or anionic dispersants. Useful nonionic dispersants include especially ethylene oxide/propylene oxide block polymers, alkylphenol polyglycol ethers and tristryrylphenol polyglycol ether, and the phosphated or sulphated derivatives thereof. Suitable anionic dispersants are especially lignosulphonates, polyacrylic acid salts and arylsulphonate/formaldehyde condensates.

Antifoams which may be present in the seed dressing formulations usable in accordance with the invention are all foam-inhibiting substances conventionally used for the formulation of active agrochemical ingredients. Silicone antifoams and magnesium stearate can be used with preference.

Preservatives which may be present in the seed dressing formulations usable in accordance with the invention are all substances usable for such purposes in agrochemical compositions. Examples include dichlorophene and benzyl alcohol hemiformal.

Secondary thickeners which may be present in the seed dressing formulations usable in accordance with the invention are all substances usable for such purposes in agrochemical compositions. Preferred examples include cellulose derivatives, acrylic acid derivatives, xanthan, modified clays and finely divided silica.

Adhesives which may be present in the seed dressing formulations usable in accordance with the invention are all customary binders usable in seed dressing products. Preferred examples include polyvinylpyrrolidone, polyvinyl acetate, polyvinyl alcohol and tylose.

The formulations for on-seed applications usable in accordance with the invention can be used to treat a wide variety of different kinds of seed either directly or after prior dilution with water. For instance, the concentrates or the preparations obtainable therefrom by dilution with water can be used to dress the seed of cereals, such as wheat, barley, rye, oats, and triticale, and also seeds of maize, soybean, rice, oilseed rape, peas, beans, cotton, sunflowers, and beets, or else a wide variety of different vegetable seeds. The formulations usable in accordance with the invention, or the dilute preparations thereof, can also be used for seeds of transgenic plants.

For treatment of seeds with the formulations usable in accordance with the invention, or the preparations prepared therefrom by adding water, all mixing units usable customarily for on-seed applications are useful. Specifically, the procedure in on-seed applications is to place the seeds into a mixer, to add the particular desired amount of the formulations, either as such or after prior dilution with water, and to mix everything until all applied formulations are distributed homogeneously on the seeds. If appropriate, this is followed by a drying operation.

The application rate of the formulations usable in accordance with the invention can be varied within a relatively wide range. It is guided by the particular content of the active ingredients in the formulations and by the seeds For seed treatment, the application rates of the compositions comprising of antioxidants and/or nutrients are generally from 0.001 to 250 g/100 kg of seeds, preferably 0.01 to 100 g/100 kg of seeds, more preferably 0.1 to 50 g/100 kg of seeds, even more preferably 0.1 to 2 g/100 kg of seeds for the antioxidants and/or at an application rate of 0.01 g/100 kg seeds to 100 g/100 kg of seeds, preferably 0.05 to 50 g/100 kg of seeds, more preferably 0.1 to 25 g/100 kg of seeds, even more preferably 0.1 to 10 g/100 kg of seeds for the nutrients.

The precise amount of antioxidants and/or nutrients will depend upon the particular plant species being treated. This may be determined by the man skilled in the art with a few experiments and may vary in plant responses depending upon the total amount of compound used, as well as the particular plant species, which is being treated. Of course, the amount of antioxidants and/or nutrients should be non-phytotoxic with respect of the plant being treated.

Although the preferred method of application of the antioxidants and/or nutrients used in the process of this invention is directly to the foliage and stems or other parts of the plants, it has been deemed that such compounds may be applied to the soil in which the plants are growing, and that such compounds will be root-absorbed to a sufficient extent so as to result in plant responses in accordance with the teachings of this invention.

In one embodiment a seed treatment composition comprises antioxidants and/or nutrients.

In one embodiment a seed treatment composition comprises antioxidants and/or nutrients and at least one other active ingredient.

In one embodiment a seed treatment composition comprises antioxidants, at least one nutrient and at least one other active ingredient.

In one embodiment a seed treatment composition comprises antioxidants and/or nutrients and Fluopyram.

In one embodiment a seed treatment composition comprises antioxidants and/or nutrients and Tebuconazole.

In one embodiment a seed treatment composition comprises antioxidants and Fluopyram.

In one embodiment a seed treatment composition comprises antioxidants and Tebuconazole.

In one embodiment a seed treatment composition comprises nutrients and Fluopyram.

In one embodiment a seed treatment composition comprises nutrients and Tebuconazole.

The following examples are illustrative of methods of improving crop safety according to the invention, but should not be understood as limiting the said instant invention.

### EXAMPLES

### Example A

Soybean seeds of the variety Williams 82 were treated with 301 mL of solutions of antioxidants (concentrations as per Table 1) per kg seeds which have either been untreated control (UTC) or treated with 0.15 mg/seed active ingredient of Fluopyram (FLU) from the commercial ILEVO® product. 1590 seeds represent 1 kg of seeds. Antioxidants were provided as an aqueous solution with a concentration as stated below. The treated seeds were seeded into soil/quartz in 5 to 8 replicates at the same day. Emergence was observed 3 days after planting. Healthy and total area of cotyledons were determined after 10 days. In Table 2, the “Increase in Healthy Area % Difference” refers to the percent difference in healthy cotyledon area in soybean plants treated with a specific antioxidant compared to those without any antioxidant. In soybeans treated with ILEVO® (Fluopyram) there was a consistent increase in percent healthy area in the cotyledons of plants treated with the antioxidants.

TABLE 1

| | | | Average | Average | |
|---|---|---|---|---|---|
| | | | Cotyledon | Healthy | Average % |
| Chemical | Antioxidant | Effective | Area | Area | Healthy |
| Treatment | Imbibition | Concentration | (mm²) | (mm²) | Area |
| FLU | Beta-Carotene | 0 μM | 237.73 | 142.71 | 60.08 |
| (0.15 mg ai/seed) | | 200 μM | 290.13 | 220.17 | 73.62 |
| | Co-enzyme Q10 | 0 μM | 292.81 | 195.10 | 66.29 |
| | | 3 μM | 312.31 | 240.72 | 76.54 |
| | Meso-Zeaxanthin | 0 ppm | 252.85 | 153.20 | 59.63 |
| | | 250 ppm | 331.07 | 230.46 | 69.68 |
| | L-ascorbic acid | 0 ppm | 307.56 | 210.37 | 67.93 |
| | | 800 ppm | 340.79 | 292.30 | 84.66 |
| | alpha tocopherol | 0 ppm | 290.71 | 199.35 | 68.20 |
| | phosphate | 100 ppm | 291.48 | 247.11 | 83.86 |
| | disodium | | | | |
| UTC | Beta-Carotene | 0 μM | 381.71 | 381.71 | 100.00 |
| | | 200 μM | 367.02 | 356.67 | 96.98 |
| | Co-enzyme Q10 | 0 μM | 368.98 | 368.98 | 100.00 |
| | | 3 μM | 416.55 | 416.55 | 100.00 |
| | Meso-Zeaxanthin | 0 ppm | 319.93 | 308.94 | 95.06 |
| | | 250 ppm | 350.59 | 349.18 | 99.66 |
| | L-ascorbic acid | 0 ppm | 398.88 | 394.03 | 98.79 |
| | | 800 ppm | 406.98 | 405.61 | 99.70 |
| | alpha tocopherol | 0 ppm | 315.24 | 302.44 | 95.28 |
| | phosphate | 100 ppm | 326.91 | 313.30 | 95.78 |
| | disodium | | | | |

μM represents the concentration as micromolar, mM represents the concentration as millimolar.

TABLE 2

| | | | Average | |
|---|---|---|---|---|
| | | | Cotyledon | |
| | | | Area (mm²) | |
| | | | Growth | Increase |
| | | | Promotion | in Healthy |
| Chemical | Antioxidant | Effective | with | Area % |
| Treatment | Imbibition | Concentration | Antioxidant | Difference |
| FLU | Beta-Carotene | 200 μM | 52.40 | 13.54 |
| | Co-enzyme Q10 | 3 μM | 19.49 | 10.25 |
| | Meso-Zeaxanthin | 250 ppm | 78.23 | 10.05 |
| | L-ascorbic acid | 800 ppm | 33.23 | 16.73 |
| | alpha tocopherol | 100 ppm | 0.76 | 15.67 |
| | phosphate | | | |
| | disodium | | | |
| UTC | Beta-Carotene | 200 μM | −14.69 | −3.02 |
| | Co-enzyme Q10 | 3 μM | 47.57 | 0.00 |
| | Meso-Zeaxanthin | 250 ppm | 30.66 | 4.59 |
| | L-ascorbic acid | 800 ppm | 8.10 | 0.91 |
| | alpha tocopherol | 100 ppm | 11.68 | 0.50 |
| | phosphate | | | |
| | disodium | | | |

### Example B

Seeds of two commercial soybean varieties were treated according to Table 5 below. ILEVO® is a commercial crop protection product comprising Fluopyram was used as a 0.15 mg active ingredient preparation of ILEVO®. Untreated Control (UTC) refers to untreated seed which only received water. “ILEVO®+Complete” refers to the use of ILEVO® in combination with the application of micro- and macronutrients according to Tables 3 and 4. ILEVO® was used in a final amount of 0.15 mg Fluopyram/per seed in addition to the macro- and micronutrients as stated above in their final concentration provided in Tables 3 and 4. The treated seeds were stored for 14 days at room temperature and were then planted in soil. Ten days after planting, the emerging seedlings were analyzed regarding the cotyledon area, the average of healthy area and the respective percentages of the healthy area as well as total dry weight of plants and roots. For each treatment and variety, 10 to 12 replicates were performed.

TABLE 3
Macronutrients

| | 2X | | |
|---|---|---|---|
| | Nutrient | mg | |
| | Solution Final | compound/ | mg |
| | Concentration | kg Seed | compound/ |
| Compound | (mM) | Treated | Seed |
| CaCl₂•2 H₂O | 4 | 176.99 | 0.111 |
| MgSO4•7 H₂O | 2 | 148.39 | 0.093 |
| K₂SO₄ | 1.24 | 62.96 | 0.040 |
| K₂HPO₄•3 H₂O | 2 | 137.38 | 0.086 |
| NH₄NO₃ | 20 | 481.60 | 0.303 |
| FeSO₄•7 H₂O | 0.1 | 8.37 | 0.005 |

TABLE 4
Micronutrients

| | 2X | | |
|---|---|---|---|
| | Nutrient | mg | |
| | Solution Final | compound/ | mg |
| | Concentration | kg Seed | compound/ |
| Compound | (μM) | Treated | Seed |
| H₃BO₃ | 10 | 0.1861083 | 0.000117 |
| ZnSO₄•7 H₂O | 4 | 0.34615 | 0.000218 |
| Na₂MoO₄•2 H₂O | 0.4 | 0.02913078 | 0.000018 |
| NiCl₂•6 H₂O | 0.44 | 0.031480988 | 0.000020 |
| CuSO₄•5 H₂O | 0.6 | 0.045092208 | 0.000028 |
| CoCl₂•6 H₂O | 0.04 | 0.002864677 | 0.000002 |
| MnSO4•H₂O | 10 | 0.00050875 | 0.0000003 |

μM represents the concentration as micromolar, mM represents the concentration as millimolar.

TABLE 5

| | | Average | Average | Average | | | Percent | Percent | |
|---|---|---|---|---|---|---|---|---|---|
| | | Cotyledon | Healthy | Percent | | Healthy | Healthy | Healthy | Cotyledon |
| Soy | | Area | Area | Healthy | Cotyledon | Area | Area | Area | Area |
| Cultivar | Treatment | (cm²) | (cm²) | Area | Area SE | SE | SE | p-Value | p-Value |
| Variety 1 | ILEVO ® | 2.25 | 1.82 | 83.68 | 0.36 | 0.32 | 4.95 | 0.0000000 | 1.20 × 10⁻¹⁶ |
| | UTC | 3.65 | 3.54 | 96.86 | 0.07 | 0.08 | 0.96 | 0.0010674 | 9.67 × 10⁻⁰⁶ |
| | ILEVO ® + | 2.64 | 2.59 | 94.57 | 0.25 | 0.25 | 3.87 | 0.0043943 | 1.67 × 10⁻⁰¹ |
| | Complete [symbol] | | | | | | | | |
| Variety 2 | ILEVO ® | 2.59 | 2.47 | 95.64 | 0.32 | 0.31 | 1.83 | 0.0000000 | 1.87 × 10⁻¹⁵ |
| | UTC | 4.08 | 3.90 | 95.59 | 0.11 | 0.12 | 0.94 | 0.9900991 | 1.39 × 10⁻⁶⁴ |
| | ILEVO ® + | 2.74 | 2.53 | 88.18 | 0.45 | 0.43 | 5.84 | 0.0428853 | 6.50 × 10⁻⁰¹ |
| | Complete [symbol] | | | | | | | | |

TABLE 6
Dry Biomass of Whole Plants and Roots

| | Biomass | | Biomass | |
|---|---|---|---|---|
| | Variety 1 (g) | | Variety 2 (g) | |
| | Whole | | Whole | |
| Treatment | Plant | Root | Plant | Root |
| UTC | 1.54 | 0.65 | 1.66 | 0.71 |
| ILEVO ® | 1.11 | 0.45 | 0.85 | 0.24 |
| ILEVO ® + Complete | 1.32 | 0.52 | 1.28 | 0.47 |

TABLE 7
Hypocotyl Length of Seedlings 10 Days
After Planting

| | Hypocotyl Length (cm) | |
|---|---|---|
| Treatment | Variety 1 | Variety 2 |
| UTC | 3.5 | 3.4 |
| ILEVO ® | 3.7 | 4.9 |
| ILEVO ® + Complete | 4.1 | 3.8 |

TABLE 8
Total Shoot Length of Seedlings 10 Days
After Planting

| | Total Shoot Length (cm) | |
|---|---|---|
| Treatment | Variety 1 | Variety 2 |
| UTC | 8.2 | 9.0 |
| ILEVO ® | 7.8 | 5.6 |
| ILEVO ® + Complete | 8.8 | 8.1 |

### Example C

Soybean seeds of the variety Williams 82 were treated using the individual nutrients shown in Table 9. All solutions were pH adjusted to pH 5.6-6.2. In addition, a seed treatment was prepared with a cobalt and molybdenum combination (“CoMo”) containing the cobalt chloride and sodium molybdate applied at the respective doses shown in Table 9. A commercial zinc solution was also applied as a seed treatment. “Macro”, “Micro” and “Complete” nutrient solution cocktails which combined all the respective nutrients from Table 9 into one nutrient solution were included as seed treatments. All seed treatments included ILEVO® comprising Fluopyram as a 0.15 mg active ingredient preparation per seed. The control seed treatment (designated “None” or “Alone” in the figures) contained only ILEVO®.

TABLE 9

| | Nutrient |
|---|---|
| | Solution |
| | Final |
| | Concentrations |
| Macro Nutrients | (mM) |
| CaCl₂•2 H₂O | 10.000 |
| MgSO4•7 H₂O | 5.000 |
| K₂SO₄ | 3.100 |
| K₂HPO₄•3 H₂O | 5.000 |
| NH₄NO₃ | 50.000 |
| FeSO₄•7 H₂O | 0.250 |
| | Nutrient |
| | Solution |
| | Final |
| | Concentrations |
| Micro Nutrients | (μM) |
| H₃BO₃ | 5.00 |
| ZnSO₄•7 H₂O | 2.00 |
| Na₂MoO₄•2 H₂O | 0.20 |
| NiCl₂•6 H₂O | 0.22 |
| CuSO₄•5 H₂O | 0.30 |
| CoCl₂•6 H₂O | 0.02 |
| MnSO4•H₂O | 5.00 |

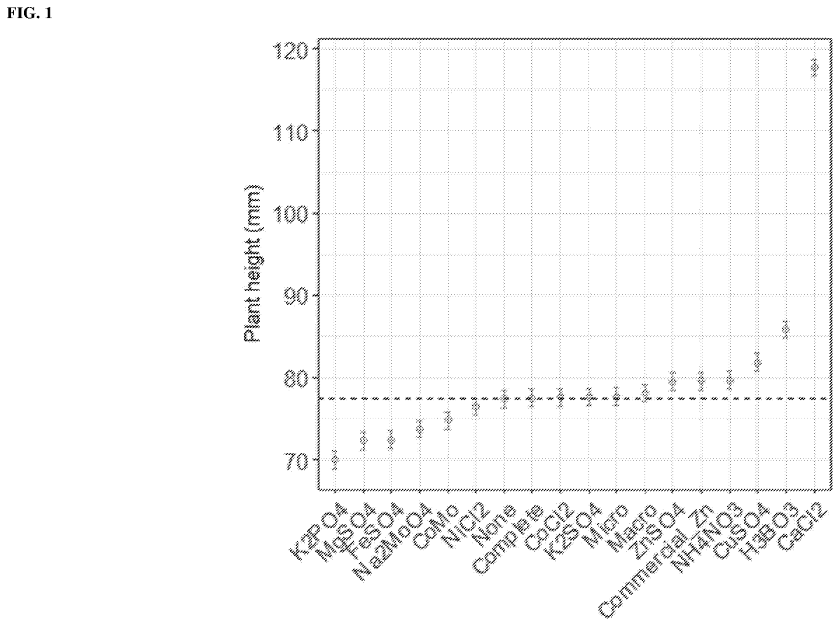

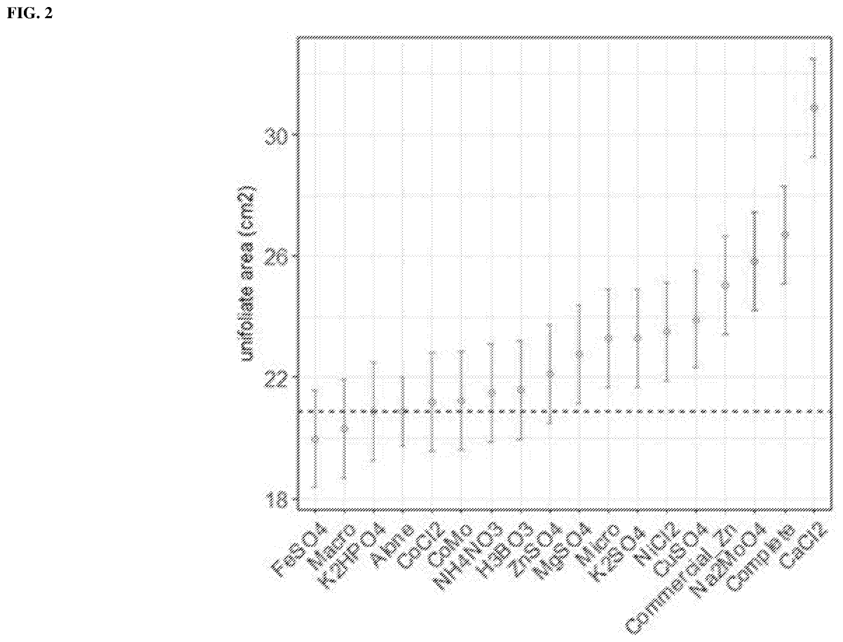

About 10 days after planting the treated seeds, the emerging seedlings were analyzed to determine their average plant height and average unifoliate leaf area. Calcium chloride significantly increased both plant height and unifoliate leaf area in soybean plants treated with ILEVO® (Fluopyram) (see FIG. 1 and FIG. 2).

### Example D

Soybean seeds of the variety Williams 82 were treated with ILEVO® comprising Fluopyram as a 0.15 mg active ingredient preparation per seed alone or in combination with 10 mM, 75 mM, or 150 mM calcium chloride (CaCl₂.2H2O). Untreated control seeds (“UTC”) were not treated with ILEVO® or calcium chloride.

Plant heights and total leaf area were determined 15 days after planting. The total leaf area was calculated by adding the unifoliate leaf area and the trifoliate leaf area of a soybean plant. Between 11 and 15 replicates were evaluated for each measurement. Average values along with their standard errors are reported. The reported p-values were determined with a t-test evaluating two treatments (i.e., the treatment with ILEVO® compared to the treatment with ILEVO® and calcium chloride) assuming unequal variances.

Addition of calcium chloride to the ILEVO® seed treatments significantly increased the height as well as the total leaf area of the soybean plants. The positive effect of the calcium chloride increased at higher concentrations indicating a dose response (see Tables 10 and 11). The positive effect of calcium chloride on the height and leaf area of soybean plants treated with ILEVO® was observed in two additional soybean varieties besides the variety Williams 82.

TABLE 10
Plant Heights 15 Days after Planting

| | Plant Height (cm) | | |
|---|---|---|---|
| | Average | Height | Height |
| Treatment | Height | SE | p-Value |
| UTC | 13.04 | 0.50 | — |
| ILEVO ® | 11.21 | 0.38 | — |
| ILEVO ® + 10 mM CaCl₂•2 H₂O | 12.93 | 0.49 | 1.03 × 10⁻⁰² |
| ILEVO ® + 75 mM CaCl₂•2 H₂O | 13.69 | 0.51 | 8.22 × 10⁻⁰⁴ |
| ILEVO ® + 150 mM CaCl₂•2 H₂O | 14.31 | 0.43 | 1.19 × 10⁻⁰⁵ |

TABLE 11
Total Leaf Area 15 Days after Planting

| | Total Leaf Area (cm²) | | |
|---|---|---|---|
| | Average | Area | Area |
| Treatment | Area | SE | p-Value |
| UTC | 50.67 | 2.95 | — |
| ILEVO ® | 38.87 | 1.64 | — |
| ILEVO ® + 10 mM CaCl₂•2 H₂O | 46.70 | 2.32 | 1.14 × 10⁻⁰² |
| ILEVO ® + 75 mM CaCl₂•2 H₂O | 53.89 | 3.47 | 1.55 × 10⁻⁰³ |
| ILEVO ® + 150 mM CaCl₂•2 H₂O | 53.03 | 2.72 | 1.81 × 10⁻⁰⁴ |

Unless defined otherwise, all technical and scientific terms herein have the same meaning as commonly understood by one of ordinary skill in the art to which this invention belongs. All publications, patents, and patent publications cited are incorporated by reference herein in their entirety for all purposes.

It is understood that the disclosed invention is not limited to the particular methodology, protocols and materials described as these can vary. It is also understood that the terminology used herein is for the purposes of describing particular embodiments only and is not intended to limit the scope of the present invention which will be limited only by the appended claims.

Those skilled in the art will recognize, or be able to ascertain using no more than routine experimentation, many equivalents to the specific embodiments of the invention described herein. Such equivalents are intended to be encompassed by the following claims.

1-14. (canceled)

15. A method for treating plants in need of improving crop safety, comprising applying antioxidants and/or nutrients to said plants, to the seeds from which they grow or to the locus in a non-phytotoxic amount which is effective to improve crop safety.

16. A method according to claim 15, wherein the improved crop safety is selected from the group consisting of a) increased area of healthy tissue, b) a lower amount of reactive oxygen species, c) an increase in cotyledon, unifoliate, and/or trifoliate leaf area, and d) an increase in plant height.

17. A method according to claim 15, wherein antioxidants and/or nutrients are applied as a seed treatment.

18. A method according to claim 15, wherein the plant is selected from the group comprising Fabaceae.

19. A method according to claim 15, wherein antioxidants and/or nutrients are applied at an application rate of 0.001 g/100 kg seeds to 250 g/100 kg of seeds for the antioxidants and/or at an application rate of 0.01 g/100 kg seeds to 50 g/100 kg of seeds for the nutrients.

20. A method according to claim 15, wherein antioxidants and/or nutrients are applied in combination with herbicides, insecticides, growth regulators, fungicides or biological control agents.

21. A method according to claim 15, wherein antioxidants and/or nutrients are applied simultaneously, that is either together or separately, or sequentially with at least one active ingredient selected from the group comprising Flupyradifurone, Prothioconazole, Tebuconazole, Fluopyram, and Imidacloprid.

22. A method according to claim 15, wherein the nutrients comprise calcium.

23. A method according to claim 22 wherein the nutrients comprising calcium are selected from the group consisting of calcium acetate, calcium ammonium nitrate, calcium borate, calcium carbonate, calcium chelate, calcium chloride, calcium cyanamide, calcium dihydrogen phosphate, calcium fluoride, calcium hydrogen phosphate, calcium hydroxide, calcium nitrate, calcium oxalate, calcium oxide, calcium phosphate, calcium silicate calcium sulfate, dolomitic lime (CaMg(CO₃)₂), hydrated lime (Ca(OH)₂), quick lime (CaO), tricalcium phosphate, and combinations thereof.

24. An agrochemical composition comprising antioxidants and/or nutrients and agriculturally suitable auxiliaries, solvents, carriers, surfactants or extenders.

25. An agrochemical composition comprising antioxidants and/or nutrients and Tebuconazole.

26. An agrochemical composition comprising antioxidants and/or nutrients and Fluopyram.

27. An agrochemical composition comprising antioxidants and/or nutrients and Flupyradifurone.

28. An agrochemical composition according to claim 24, wherein the nutrients are selected from the group consisting of calcium acetate, calcium ammonium nitrate, calcium borate, calcium carbonate, calcium chelate, calcium chloride, calcium cyanamide, calcium dihydrogen phosphate, calcium fluoride, calcium hydrogen phosphate, calcium hydroxide, calcium nitrate, calcium oxalate, calcium oxide, calcium phosphate, calcium silicate, calcium sulfate, dolomitic lime (CaMg(CO₃)₂), hydrated lime (Ca(OH)₂), quick lime (CaO), tricalcium phosphate, and combinations thereof.

29. An agrochemical composition comprising antioxidants and/or nutrients and Imidacloprid.

30. The method according to claim 15, wherein the nutrients are macro-nutrients.

31. The method according to claim 15, wherein the nutrients are micro-nutrients.

32. The method according to claim 15, wherein the nutrients are a combination of micro-nutrients and macro-nutrients.
